(19) United States
(12) Patent Application Publication
(10) Pub. No.: US 2004/0008923 A1
(43) Pub. Date: Jan. 15, 2004

(54) Method for embedding digital watermark information

(76) Inventors: Kousuke Anzai, Kawasaki (JP); Hiroshi Yoshiura, Tokyo (JP); Isao Echizen, Yokohama (JP)

Correspondence Address: MCDERMOTT WILL & EMERY, 600 13TH STREET, N.W., WASHINGTON, DC, 20005-3096, US

(21) Appl. No.: 10/418,287

(22) Filed: Apr. 18, 2003

(30) Foreign Application Priority Data
Jul. 10, 2002 (JP) 2002-200741

(51) Int. Cl. G02B 6/26; G02B 6/42

(52) U.S. Cl. 385/16

(57) ABSTRACT

When watermark information is embedded in moving image data formed of plural still image frames arranged in time sequence, the motion vector and deformation quantity (motion estimation data) of each block in the current frame are estimated. By using this motion estimation data in both digital watermark embedding process and encoding process, it is possible to make watermark embedding and encoding faster while suppressing the degradation of the content and improving the survivability of the embedded information.

### INCORPORATION BY REFERENCE

This application claims priority based on a Japanese patent application, No. 2002-200741, filed on Jul. 10, 2002, the entire contents of which are incorporated herein by reference.

### BACKGROUND OF THE INVENTION

The present invention relates to an information embedding method and apparatus and, in particular, to a method and apparatus for embedding another information in digital contents.

In recent years, contents of images and music have been digitized and circulated via storage media or communication networks. In order to protect the copyright of such digital contents, digital watermark technique is regarded as important. In this digital watermark technique, copy control information and copyright information are embedded in contents by making a modification of such a degree as not to be noticed by human visual and auditory senses in the contents. As a result, it is possible to limit the number of times of copy of contents utilizing data processing apparatuses or identify the copyright holder of illegally copied contents.

To put the digital watermark technique to practical use, it is necessary to satisfy the following two requirements.

(1) Suppression of Degradation of Contents:

For example, in embedding digital watermark information in either a still or moving image content, a modification made in the image data must not prevent enjoyment of the content. In other words, a modification made in a part of contents must not be conspicuous to human visual and auditory senses.

(2) Improvement of Survivability:

Even if image processing and voice processing are applied, embedded information, i.e., a modification made in contents, must not be easily degraded.

To satisfy the above described conditions, it is necessary to optimize the modification in terms of position and degree or magnitude according to the features of the content. By taking an image as a representative example of contents, conventional digital watermark techniques will hereafter be analyzed.

In the case of image data, making an inappropriate modification in the state (luminance or color) values of pixels in such an area that the image state transition there is comparatively flat or forms a contour may cause conspicuous unnaturalness in the modified position. However, where the pixel value changes irregularly due to the subject, a comparatively large modification made in pixels is not conspicuous to human eyes. Paying attention to this nature, a digital watermark technique has been proposed in, for example, IEEE Trans. Consumer Electronics, Vol. 45, No. 4, pp. 1150-1158 (1999). This technique analyzes the distribution of luminance in an image frame in which watermark information is to be embedded and recognizes which portions of the subject are disorderly in luminance. In such disorderly portions where modified pixel values are hard to be conspicuous, a large modification is made. In a portion where modified pixel values are easy to be conspicuous, modification is inhibited or limited to a low degree.

Digital watermark information is to be embedded not only in still pictures but also in moving pictures. Moving picture data is formed of a plurality of still picture frames arranged in time series and a moving picture is sometimes enjoyed as individual still pictures by stopping the frame feed.

In embedding digital watermark information in a moving picture, it is therefore necessary to make pixel value-modified positions inconspicuous in both still and moving picture states. Accordingly, Japanese Patent Laid-open No. 2000-175019 (European Patent Laid-open No. EP1006730A2) discloses a technique that optimizes the modification of a moving picture in terms of position and degree by considering its features as both still and moving images. To be concrete, watermark information is embedded in moving picture data formed of a plurality of still picture frames arranged in time series by performing the steps of: detecting a motion vector and a deformation quantity (features as a moving image) for each image block of the current frame; selecting a pixel modification ratio specification rule for each block according to the detected motion quantities; selecting as many pixels as specified by the rule in the block from the luminance-modifiable pixels determined according to the image state (features as a still image) of the block; and embedding watermark information by applying a luminance modification process to the pixels.

To make embedded watermark information inconspicuous in the motion picture state, this prior art involves detecting a motion vector and a deformation quantity (features as a moving image) on the basis of each image block of the current frame. However, this detecting process must perform many calculations and therefore spend a great amount of time. It is needed to perform watermark embedding as fast as possible.

### SUMMARY OF THE INVENTION

Usually, moving pictures circulated as contents are compressed by moving picture compressing techniques such as MPEG (Moving Picture Expert Group) encoders implemented by hardware or software. In the process of encoding, motion vectors and deformation quantities (features as a moving image) are estimated.

The present invention provides a technique for reducing the burden of processing by having a common estimation facility utilized by both the watermark embedding process and the compressing process such as MPEG encoding. The estimation process estimates motion vectors and deformation quantities necessary for optimizing the modification in term of position and degree by taking into consideration the features of target contents as moving images.

According to a first aspect of the present invention, there is provided an information embedding method for embedding a digital watermark in a content, the method comprising: a first step of estimating the motion vector and deformation quantity of each block contained in a frame of the content by comparing the frame with another frame of the content; a second step of embedding information in one of the frames in concern compared in the first step by using the motion vectors and deformation quantities estimated in the first step; and a third step of compressing the content including the information-embedded frame obtained in the second step by using the motion vectors and deformation quantities estimated in the first step.

According to a second aspect of the present invention, there is an information embedding method for embedding a digital watermark in a compressed content, the method comprising: a first step of extracting the motion vector and deformation quantity of each block contained in a frame of the compressed content; a second step of extending the compressed content so as to allow information to be embedded in frames of the content, and by using the motion vectors and deformation quantities extracted in the first step, embedding information in one of the frames in which the information is able to be embedded; and a third step of compressing the content including the information-embedded frame obtained in the second step by using the motion vectors and deformation quantities extracted in the first step.

According to a third aspect of the present invention, there is provided an information embedding method for embedding a digital watermark in a content, the method comprising: a first step of estimating the motion vector and deformation quantity of each block contained in a frame of the content by comparing the frame with another frame of the content; a second step of compressing the content by using the motion vectors and deformation quantities estimated in the first step; a third step of extending the compressed content obtained in the second step so as to allow information to be embedded in frames of the content, and by using the motion vectors and deformation quantities estimated in the first step, embedding information in one of the two frames in which the information is able to be embedded; and a fourth step of compressing the content including the information-embedded frame obtained in the second step by using the motion vectors and deformation quantities estimated in the first step.

In practical application, other feature of contents, such as the luminance distribution in each still image frame or in each image block, may also be taken into consideration.

In addition, if, for example, the block matching method is applied to the MPEG encoding of the content, the obtained motion vectors and deformation quantities are directly used as those estimated in the first step.

The present invention enables faster embedding of watermark information.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a diagram for explaining the principle of a watermark embedding and encoding process;

FIG. 2 shows the schematic configuration of a digital watermark embedding and encoding device 103;

FIG. 3 is a flowchart showing a procedure of processing done by the digital watermark embedding and encoding device 103;

FIG. 4 is a diagram for explaining the principle of a watermark embedding and encoding process in a second embodiment;

FIG. 5 is a diagram for explaining the principle of a watermark embedding and encoding process in a third embodiment;

FIG. 6 shows the schematic configurations of a watermark embedding device 503 and an encoding device 508 in the third embodiment;

FIG. 7 is a diagram for explaining the principle of a watermark embedding and encoding process in a fourth embodiment;

FIG. 8 shows the schematic configurations of an encoding device 703 and a watermark embedding device 708 in the fourth embodiment;

FIG. 9 is a diagram for explaining the principle of the block matching method, a major process for motion estimation; and

FIG. 10 is a diagram for explaining a current frame and a reference frame which are used for motion estimation during encoding.

### DESCRIPTION OF THE PREFERRED EMBODIMENTS

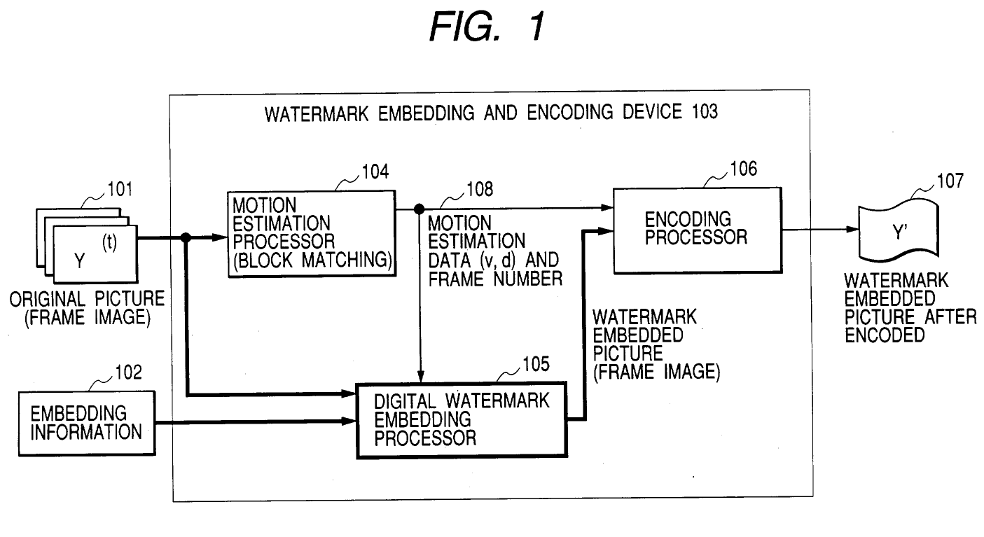

With reference to FIGS. 1 through 10, embodiments of the present invention will hereinafter be described. Note that in these figures, configuration elements are given the same number if they have the same function.

In these embodiments, a moving picture is assumed as contents. Since moving picture data is formed of a plurality of still image frames arranged in time sequence, it is possible to embed watermark information in the moving picture by modifying some pixels in each still image frame. In the embodiments described below, specific pixels selected from each still image frame are modified in luminance in such a range as not to give a sense of incompatibility to human eyes.

FIG. 1 is a diagram for explaining the principle of a watermark embedding and encoding process in a first embodiment. As shown in FIG. 1, a digital watermark embedding and encoding device 103 inputs an original picture 101 (moving image data in which watermark information is to be embedded) and embedding information 102. From them, the watermark embedding and encoding device 103 creates a watermark embedded picture 107 (moving image data in which watermark information is embedded).

In the watermark embedding and encoding device 103, a motion estimation processor 104 inputs the original picture 101 and calculates a motion vector v and a deformation quantity d in each frame by performing a motion estimation process between frames constituting a part of the original picture. Hereinafter, a frame number, a motion vector v and a deformation quantity d are generically denoted as motion estimation data 108. The motion estimation process uses, for example, the block matching method.

A watermark embedding processor 105 inputs the original picture 101 and motion estimation data 108 for each frame and creates watermark embedded picture. Each watermark embedded picture is created for one of the frames used to calculate the corresponding motion estimation data 108. An encoding processor 106 inputs the motion estimation data 108 and the watermark embedded picture and creates a watermark-embedded picture after encoded 107.

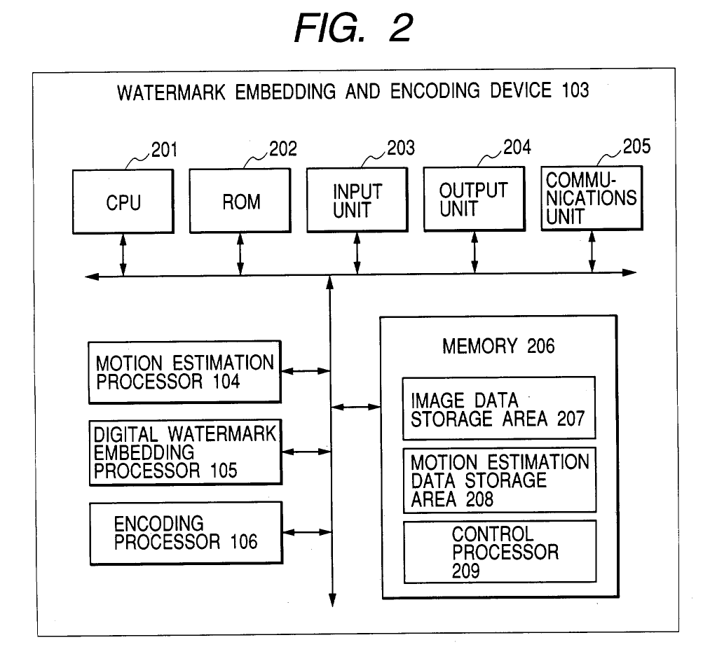

FIG. 2 is a schematic configuration of the digital watermark embedding and encoding device 103 shown in FIG. 1. The watermark embedding and encoding device 103 has a CPU 201, a ROM 202, an input unit 203, an output unit 204, a communications unit 205 and a memory 206. The CPU 201 controls the operation of the digital watermark embedding and encoding device 103 as a whole. The memory 206 stores various processing programs, image data and other data used for controlling the operation of the digital watermark embedding and encoding device 103. The input unit 203 inputs image data from storage media, such as DVD, CD-ROM and HDD, and wired or wireless communication media. The input unit 203 also inputs embedding information. The output unit 204 outputs received image data. If the image data includes audio data, it also outputs audio data. The communications unit 205 controls the communications with other processing devices via a network such as the Internet or an intranet or a dedicated signal bus such as SCSI or RS422.

In the digital watermark embedding and encoding device 103, a motion estimation processor 104, a digital watermark embedding processor 105 and an encoding processor 106 are provided as circuits implemented on LSI chips and a control processor 209 is provided as programs deployed in the memory 206. Further, in the memory 206, the digital watermark embedding and encoding device 103 has an image data storage area 207 for storing received original picture data, watermark-embedded pictures before encoding and watermark-embedded encoded pictures after encoded and a motion estimation data storage area 208 for storing motion estimation data 108 output from the motion estimation processor 104. Alternatively, the processors 104, 105 and 106 may be implemented as programs deployed in the memory 206 in the same manner as the control processor 209.

Each program is executed by the CPU 201. Each program may be partly or wholly introduced into the digital watermark embedding and encoding device 103 from a portable storage medium or another server machine via a communication medium.

Under control of the control processor 209, image data received through the input unit 203 is partly or wholly stored in the image data storage area 207 together with received embedding information in a processable form.

The motion estimation processor 104 performs a frame-to-frame motion estimation process on the image data deployed in the memory 206 and outputs the obtained motion estimation data 108 to the data storage area 208 in the memory 206. Alternatively, the motion estimation data may be output one after another to the watermark embedding processor 105 and the encoding processor 106.

The digital watermark embedding processor 105 performs a watermark information embedding process on an original picture deployed in the memory by using the embedding information, motion estimation data and features as still images (DCT coefficients, irregularities, etc.) obtained from the original picture and outputs the obtained watermark-embedded picture to the memory.

The encoding processor 106 performs an encoding process to the watermark-embedded images by using the obtained motion estimation data and outputs the watermark-embedded encoded images to the memory.

The control processor 209 controls the output of watermark-embedded encoded images from the encoding processor 105 to the output unit 203 and the output of watermark-embedded encoded images to external equipment via the communications unit 205.

As mentioned above, the processors 104, 105 and 106 may be implemented as programs deployed in the memory 206 of this embodiment shown in FIG. 2. In this case, it is preferable to store the programs in a tamper-resistant area. Further, if the digital watermark embedding and encoding device 103 is a device like a PC where programs can be installed relatively easily and image data is received by a reception function using the OS's utility or an application under the OS, it is preferable that the received image data is accessed through the processors stored in the tamper-resistant area.

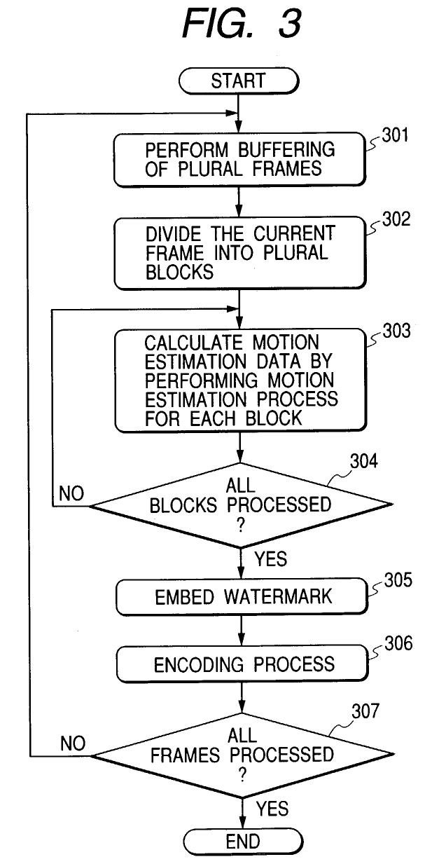

FIG. 3 is a flowchart showing a procedure of processing performed by the digital watermark embedding and encoding device 103.

In step 301, the control processor 209 temporarily stores a part or all of original image data, which was received via the input unit 203, into the image data storage area 207 of the memory 206.

In step 302, of the original image data stored wholly or partly, the control processor 209 divides each current still picture where watermark information is to be embedded (hereinafter denoted as a current frame) into plural image blocks of a predetermined size, for example, 16 pixels times 8 pixels (=128 pixels) and stores the divided image data in the image data storage area 207 of the memory 206.

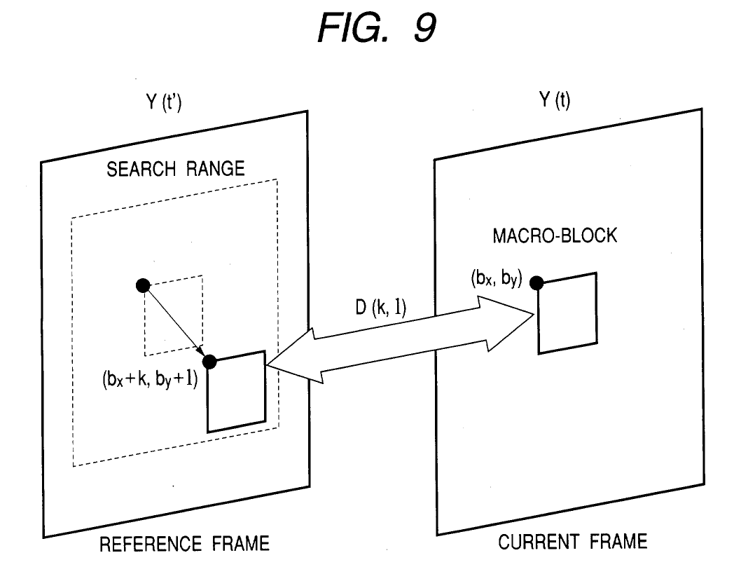

In step 303, in order to estimate motions of the objects contained in the current frame, the motion estimation processor 104 compares the current frame with a frame which is distant by K frames along the time axis (hereinafter denoted as a reference frame) on a block by block basis. As described in detail with FIG. 9, this motion estimation process calculates a motion vector and a deformation quantity for each block. The value of the parameter K (for example K=4) which indicates the current-to-reference frame distance in terms of frames is determined by the user depending on the encoding algorithm and the like.

The aforementioned motion estimation can be implemented by, for example, a known technique reported in A Review and New Contribution, Proc. IEEE, Vol. 83, No. 6, pp. 858-876, (1998). The result of motion estimation is represented by a motion vector and deformation quantity as described later with reference to FIG. 9.

In step 304, the control processor 209 judges whether the motion estimation process is performed on all blocks of the current frame and, if not, it performs the step 303 process on the next block.

In step 305, the digital watermark embedding processor 105 analyzes the still image contained in the current frame and determines the modification margin of each pixel based on the DCT coefficients and/or irregularities or the like. Next, using the motion estimation data calculated for each block, the watermark embedding processor 105 determines what amount of modification is to be done on each pixel or block basis. Then, the watermark embedding processor 105 embeds a watermark in the current frame by modifying the pixel values and stores the watermark-embedded picture in the image data storage area 207.

This embodiment may also be configured in such a manner that the watermark embedding process is performed on the reference frame.

For example, if each still image frame of the motion picture consists of 720×480 pixels and is divided into 16 by 8 pixel blocks, 45 by 60 (=2700) blocks are formed per frame. If 6-bit information (a number of 0 to 63 in a character code representing 64 different characters) is embedded in a frame, each bit can be assigned 450 blocks.

If the aforementioned 2700 blocks are divided into N groups associated with N character codes and 6-bit information is assigned to each of the N group, that is 2700/N blocks, one bit can be used for assigning 450/N blocks.

Each bit of a bit pattern forming watermark information may previously be associated with mutually discrete plural image blocks in a still image frame. This allows N characters in the character code to be embedded as watermark information in each frame. Practically, for example, bit information “1” can be written to a bit position by raising the luminance of each pixel according to the aforementioned amount of modification in the plural image blocks associated with the bit position. Likewise, bit information “0” can be written by lowering the luminance of each pixel according to the aforementioned amount of modification.

Some blocks in each frame may not allow luminance modification due to the state of the image in the frame. Normally, however, luminance modification is always possible in at least one block since each bit is assigned mutually distinct plural image blocks. Thus the watermark information can be surely embedded.

Such associating relations as described above between image blocks and bit information are stored beforehand in the form of a table in the memory 206 when watermark information is given. This allows the digital watermark embedding device 105 to know what information to write to each block by referring to the memory 206.

Watermark information may consist of any number of bits. For example, 8-bit watermark information may be embedded instead of the above-described 6-bit watermark information. In addition, instead of associating a different bit with each image block group in the above-described manner, a different character of, for example, the above-described 6-bit character code representing 64 different characters, may be associated with each block group beforehand. In this case, the state of pixels in an image block group is modified if the associated character is to be embedded. Furthermore, the amount of luminance modification may be controlled by changing the number of pixels whose luminance is modified instead of modifying the luminance of every pixel in a block. In this case, instead of an amount of luminance modification applied to every pixel which can be set to any of, for example, 128 luminance levels, i.e., levels 0 through 128, the number of pixels to be modified is specified while the amount of luminance modification is fixed to, for example, one level.

In step 306, using the motion estimation data obtained in step 303, the encoding processor 106 performs an encoding process on a watermark-embedded picture stored in the image data storage area 207. After the watermark-embedded image is encoded, the encoding processor 106 stores the watermark-embedded encoded image in the image data storage area 207. In the case of MPEG encoding, DCT transformation, quantizing of DCT coefficients and reversible compression are performed in this encoding process.

In step 307, the control processor 209 judges whether the above-described processes are performed on all frames and, if not, the processing goes back to step 301 to process the subsequent frame.

FIG. 9 is provided to explain the principle of the block matching method, a major technique for motion estimation. In this motion estimation method, the motion vector of each MPEG macro-block (16 by 16 pixels) is estimated. Practically, its procedure is as follows. First, difference sum D (k, 1) is calculated between a macro-block in the current frame image Y(t) and a macro-block in the reference frame Y(t′), where the later macro-block is shifted from the former block by (k, 1). The sum difference D (k, 1) is calculated by adding up the absolute difference between each corresponding two pixels for i,j=0 through 15. Each absolute difference is expressed by:

|Y(t)_{bx+i, by+j}−Y(t′)_{bx+k+i, by+l+j}|

where, (bx, by) indicates the start pixel position of the macro-block. Second, the sum difference D (k, 1) is calculated in a search range (generally −15<=k, l<=15). That is, 31 by 31 sum differences are created. Third, of the 31 by 31 sum differences Ds, the smallest one is regarded as the deformation quantity d of the macro-block of concern. The motion vector v of the macro-block of concern is the position of the coordinates of the macro-block creating this smallest sum difference, relative to the position of the macro-block of concern.

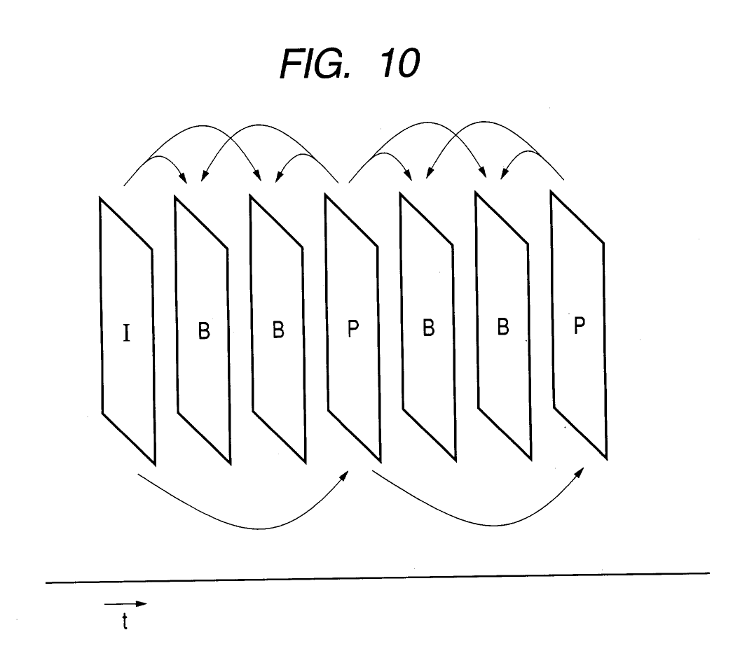

FIG. 10 is provided to explain current and reference frames assumed when motion estimation (block matching method) is done during MPEG encoding. In the case of MPEG encoding, each frame is treated as an I frame, a P frame or a B frame. I frames are encoded by using only intra-frame information. P frames are encoded by inter-frame prediction from past frames. B frames are encoded by inter-frame prediction from both past and earlier frames. In the figure, each arrow indicates two frames compared during motion estimation. It starts from a current frame and ends at a reference frame.

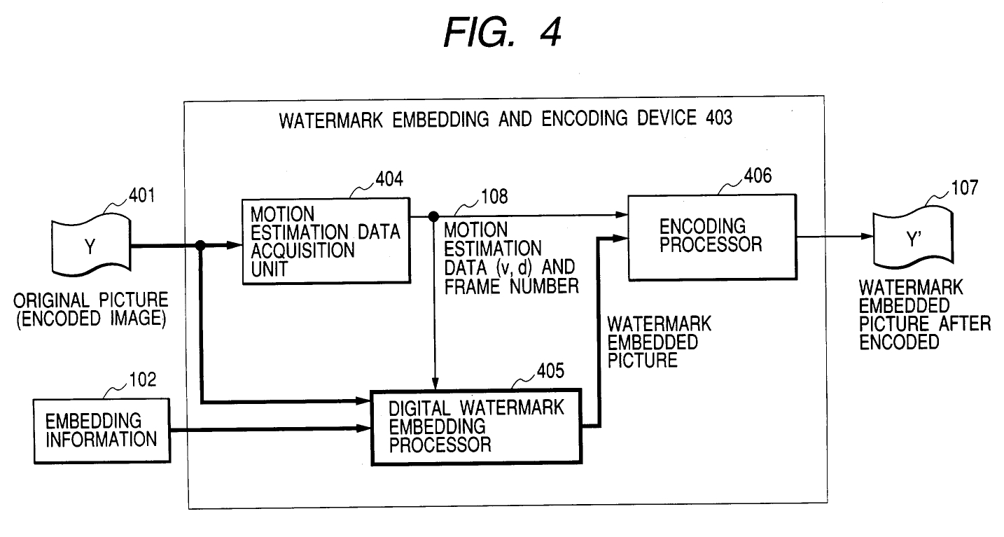

FIG. 4 is a diagram for explaining the principle of a watermark embedding and encoding process in a second embodiment. As shown in FIG. 4, a watermark embedding and encoding device 403 inputs an encoded original picture 401 and embedding information 102. From them, the watermark embedding and encoding device 403 creates a watermark-embedded encoded picture 107.

In the watermark embedding and encoding device 403, a motion estimation data acquisition unit 404 inputs the original picture 401, encoded according to MPEG or the like, and acquires motion estimation data 108 from the original picture 401. A digital watermark embedding processor 405 inputs the original picture 401 and motion estimation data 108 and creates a watermark-embedded picture. In this process, instead of fully expanding the encoded image 401, the watermark embedding processor 405 expands it to such an extent that a watermark can be embedded. Then, a watermark-embedded picture is created by raising or lowering, depending on the embedding information 102, the value of pixels (RGB value, luminance value, color information, etc.) or DCT coefficients after DCT transformation by a specified amount.

An encoding processor 406 inputs the motion estimation data 108 and the watermark-embedded picture created by 405 and re-encodes the images to create a watermark-embedded picture after encoded 107.

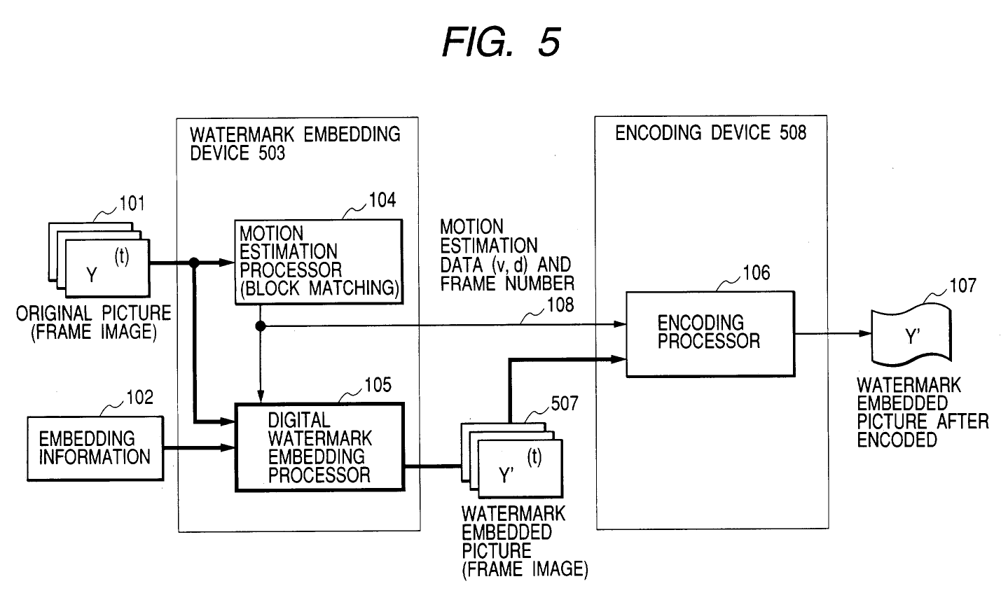

FIG. 5 is a diagram for explaining the principle of a watermark embedding and encoding process in a third embodiment. Unlike in the first and second embodiments, a watermark embedding device is separated from an encoding device.

As shown in FIG. 5, a watermark embedding device 503 inputs an original picture 101 and embedding information 102. From them, the watermark embedding device 503 creates motion estimation data 108 and a watermark-embedded picture 507.

In the watermark embedding device 503, a motion data estimation processor 104 inputs the original picture 101 and obtains motion estimation data 108. A digital watermark embedding processor 105 inputs the original picture 101 and motion estimation data 108 and creates a watermark-embedded picture 507.

In an encoding device 508, an encoding processor 106 inputs the motion estimation data 108 and the watermark-embedded picture 507 and creates a watermark-embedded picture after encoded 107.

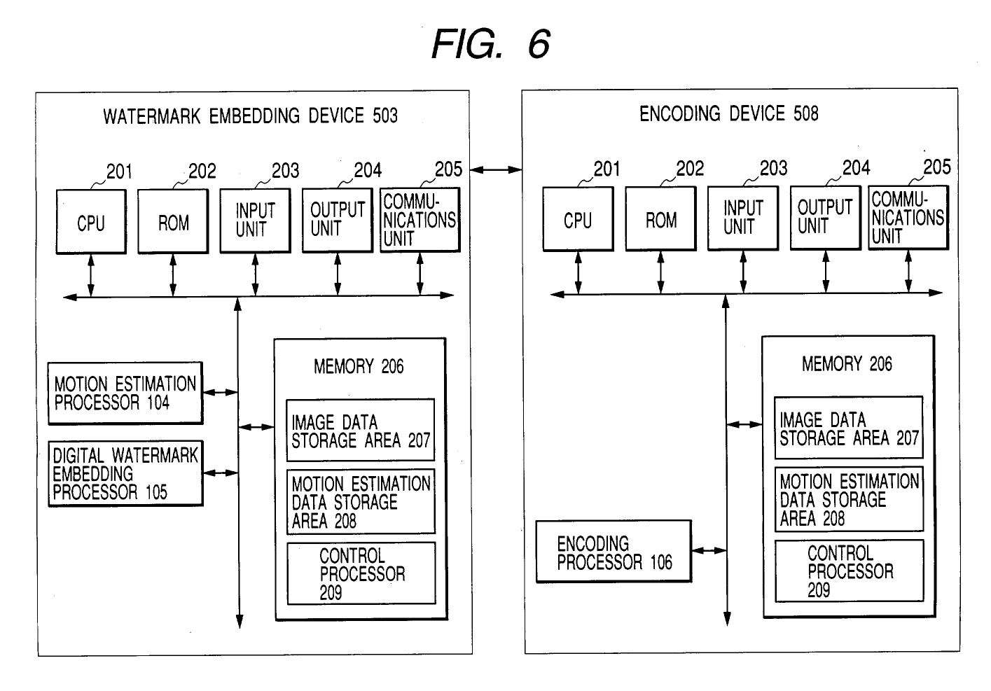

FIG. 6 shows schematic configurations of the watermark embedding device 503 and encoding device 508 shown in FIG. 5. As shown in FIG. 6, either of the embedding device 503 and the encoding device 508 has a CPU 201, a ROM 202, an input unit 203, an output unit 204, a communications unit 205 and a memory 206.

The input units 203, output units 204 and communications units 205 allow the watermark embedding device 503 and encoding device 508 to exchange image data, motion estimation data, embedding information, etc.

In the watermark embedding device 503, a motion estimation processor 104 and a watermark embedding processor 105 are provided as circuits implemented on LSI chips and a control processor 209 is provided as programs deployed in the memory 206. Further, in the memory 206, the watermark embedding device 503 has an image data storage area 207 for storing received image data and both watermark-embedded pictures before encoding and watermark-embeded pictures after encoded; and a motion estimation data storage area 208 for storing motion estimation data 108 output from the motion estimation processor 104.

In the encoding device 508, an encoding processor 106 is provided as a circuit implemented on LSI chips and a control processor 209 is provided as programs deployed in the memory 206. Further, in the memory 206, the encoding device 508 has an image data storage area 207 for storing received image data and both watermark-embedded pictures before encoding and watermark-embeded pictures after encoded; and a motion estimation data storage area 208 for storing received motion estimation data 108.

If the digital watermark embedding device 503 and encoding device 508 are devices like PCs where programs can be installed relatively easily and image data is received by a reception function using the OS's utility or an application under the OS, it is preferable that the received image data is accessed through the processors stored in the tamper-resistant area.

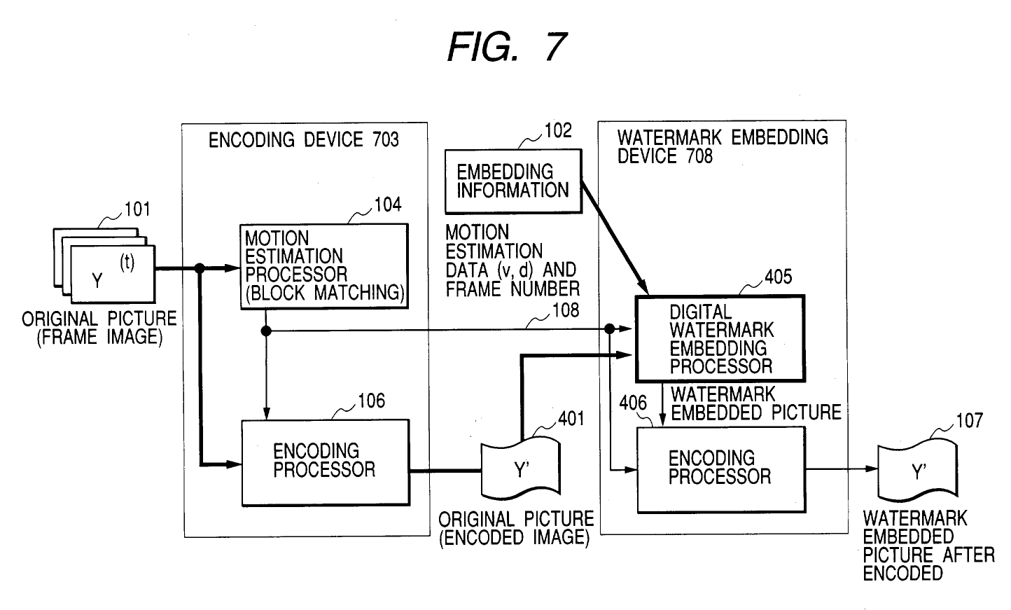

FIG. 7 is a diagram for explaining the principle of a watermark embedding and encoding process in a fourth embodiment. Similar to the third embodiment, a watermark embedding and encoding device 708 is separated from an encoding device 703.

As shown in FIG. 7, the encoding device 703 inputs an original picture 101 and embedding information 102 and creates motion estimation data 108 and a watermark embedded picture after encoded 107. In the encoding device 703, a motion data estimation processor 104 inputs the original picture 101 and obtains motion estimation data 108. An encoding processor 106 inputs the original picture 101 and motion estimation data 108 and creates the encoded original picture 401.

The watermark embedding device 708 inputs the motion estimation data 108 and encoded picture 401 created by the encoding device 703 and creates an watermark-embedded picture after encoded 107. In the watermark embedding device 708, a digital watermark embedding processor 405 inputs the motion estimation data 108, the encoded original picture 401 and the embedding information 102 and creates a watermark-embedded picture. Then, an encoding processor 406 inputs the motion estimation data 108 and the created watermark-embedded picture and creates the watermark-embedded picture after encoded 107.

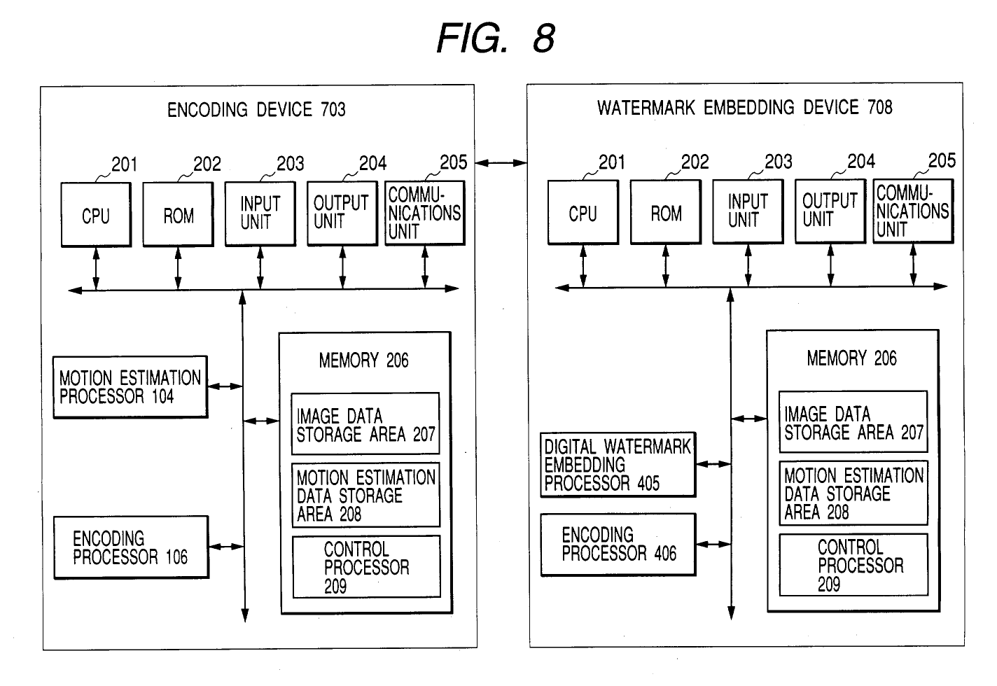

FIG. 8 shows schematic configurations of the encoding device 703 and watermark embedding device 708 shown in FIG. 7.

As shown in FIG. 8, either of the encoding device 703 and the watermark embedding device 708 has a CPU 201, a ROM 202, an input unit 203, an output unit 204, a communications unit 205 and a memory 206. The encoding device 703 and watermark embedding device 708 performs exchange of image data, motion estimation data, embedding information, etc. through the input units 203, output units 204 and communications units 205.

In the encoding device 703, a motion estimation processor 104 and an encoding processor 106 are provided as circuits implemented on LSI chips and a control processor 209 is provided as programs deployed in the memory 206. Further, in the memory 206, the encoding device 703 has an image data storage area 207 for storing received image data and watermark embedded image before and after encoded; and a motion estimation data storage area 208 for storing received motion estimation data 108.

In the watermark embedding device 708, a digital watermark embedding processor 405 and an encoding processor 406 are provided as circuits implemented on LSI chips and a control processor 209 is provided as programs deployed in the memory 206. Further, in the memory 206, the watermark embedding device 708 has an image data storage area 207 for storing received image data and watermark-embedded images before and after encoded; and a motion estimation data storage area 208 for storing motion estimation data 108 received from the motion estimation processor 104.

If the digital watermark embedding device 703 and encoding device 708 are devices like PCs where programs can be installed relatively easily and image data is received by a reception function using the OS's utility or an application under the OS, it is preferable that the received image data is accessed through the processors stored in the tamper-resistant area.

In the embodiments described so far, motion estimation data intended originally to be used in encoding process is utilized also in digital watermark embedding process. This makes it possible to reflect features of a moving picture as both moving and still images in the optimization of watermark embedding in the moving picture and enables faster embedding of watermark information with suppressed degradation of the image quality and improved survivability of the watermark information.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. A digital watermark information embedding method for embedding a digital watermark in a content, the method comprising the steps of:
a first step of estimating the motion vector and deformation quantity of each block contained in a frame of the content by comparing the frame with another frame of the content;
a second step of embedding information in one of the frames compared in the first step by using the motion vectors and deformation quantities estimated in the first step; and
a third step of compressing the content including the information-embedded frame obtained in the second step by using the motion vectors and the deformation quantities estimated in the first step.

2. A digital watermark information embedding method for embedding a digital watermark in a compressed content, the method comprising the steps of:
a first step of extracting the motion vector and deformation quantity of each block contained in a frame of the compressed content;
a second step of extending the compressed content so as to allow information to be embedded in frames of the content, and by using the motion vectors and the deformation quantities extracted in the first step, embedding information in one of the frames in which the information is able to be embedded; and
a third step of compressing the content including the frame, which was information-embedded in the second step, by using the motion vectors and the deformation quantities extracted in the first step.

3. A digital watermark information embedding method for embedding a digital watermark in a content, the method comprising the steps of:
a first step of estimating the motion vector and deformation quantity of each block contained in a frame of the content by comparing the frame with another frame of the content;
a second step of compressing the content by using the motion vectors and deformation quantities estimated in the first step;
a third step of extending the compressed content obtained in the second step so as to allow information to be embedded in frames of the content, and by using the motion vectors and the deformation quantities estimated in the first step, embedding information in one of the frames in which the information is able to be embedded; and
a fourth step of compressing the content including the frame, which was information-embedded in the second step, by using the motion vectors and the deformation quantities estimated in the first step.

4. A digital watermark information embedding method for embedding a digital watermark in a content, the method comprising the steps of:
a first step of obtaining inter-frame motion information as regards plural frames of the content;
a second step of embedding information in one of the frames by using the motion information obtained in the first step; and
a third step of compressing the content including the frame, which was information-embedded in the second step, by using the motion information obtained in the first step.

5. A digital watermark embedding method according to claim 4, wherein the motion information is the motion vector and/or deformation quantity of each block in a frame obtained in the first step by comparing the frame with another frame.

6. A digital watermark embedding method according to claim 4, wherein when information is embedded in one of the frame in the second step, features of a still image determined in the frame are utilized in addition to the motion information.

7. A digital watermark information embedding method for embedding a digital watermark in a compressed content, the method comprising the steps of:
a first step of extracting inter frame motion information as regards plural frames of the compressed content;
a second step of extending the compressed content so as to allow information to be embedded in frames of the content, and by using the motion information extracted in the first step, embedding information in one of the plural frames in which the information is able to be embedded; and
a third step of compressing the content including the frame, which was information-embedded in the second step, by using the motion information extracted in the first step.

8. A digital watermark embedding method according to claim 7, wherein the motion information is the motion vector and/or deformation quantity of each block in a frame obtained in the first step by comparing the frame with another frame.

9. A digital watermark embedding method according to claim 7, wherein when information is embedded in one of the frame in the second step, features of a still image determined in the frame are utilized in addition to the motion information.

10. A digital watermark information embedding method for embedding a digital watermark in a content, the method comprising the steps of:
a first step of obtaining inter-frame motion information as regards plural frames of the content;
a second step of compressing the content by using the motion information obtained in the first step;
a third step of extending the compressed content obtained in the second step so as to allow information to be embedded in frames of the content, and by using the motion information obtained in the first step, embedding information in one of the plural frames in which the information is able to be embedded; and
a fourth step of compressing the content including the frame, which was information-embedded in the third step, by using the motion information obtained in the first step.

11. A digital watermark embedding method according to claim 10, wherein the motion information is the motion vector and/or deformation quantity of each block in a frame obtained in the first step by comparing the frame with another frame.

12. A digital watermark embedding method according to claim 10, wherein when information is embedded in one of the frame in the second step, features of a still image determined in the frame are utilized in addition to the motion information.
